(19) United States
(12) Patent Application Publication
(10) Pub. No.: US 2024/0404254 A1
(43) Pub. Date: Dec. 5, 2024

(54) VIDEO-LEVEL MEDICAL IMAGE ANNOTATION

(71) Applicant: KONINKLIJKE PHILIPS N.V., EINDHOVEN (NL)

(72) Inventors: Jiahong Ouyang, Cambridge, MA (US); Li Chen, Cambridge, MA (US); Ye Li, Cambridge, MA (US); Alvin Chen, Cambridge, MA (US)

(21) Appl. No.: 18/675,638

(22) Filed: May 28, 2024

Related U.S. Application Data
(60) Provisional application No. 63/469,576, filed on May 30, 2023.

(51) Int. Cl. G06V 10/774; G06V 10/26; G06V 10/764; G06V 10/776; G06V 10/80; G06V 10/82

(52) U.S. Cl. CPC G06V 10/774; G06V 10/26; G06V 10/764; G06V 10/776; G06V 10/806; G06V 10/82; G06V 2201/03; G06V 2201/07

(57) ABSTRACT

Techniques for training models, using video-level annotations as additional supervision, to generate both video-level and frame-level predictions based on medical images are disclosed. In some examples, medical imaging data is received including frame-level annotations and video-level annotations. A training dataset may be generated comprising frame-level ground truth data and video-level ground truth data, and the model is trained, using the training dataset, to generate frame-level feature localizations/segmentations and/or video-level feature predictions on new medical imaging data. In some examples, a model includes a frame-to-video feature encoder that learns to generate video-level predictions from frame-level predictions. The frame-to-video feature encoder may be jointly trained based on video-level annotations along with frame-level annotations during training.

### CROSS-REFERENCE TO RELATED APPLICATION

This Application claims the benefit of and priority to U.S. Provisional Application No. 63/469,576 filed May 30, 2023, the contents of which are herein incorporated by reference.

### TECHNICAL FIELD

This application relates to feature detection and segmentation in medical images. More specifically, this application relates to training models to perform feature localization using medical image annotations.

### BACKGROUND

Various medical imaging modalities can be used for clinical analysis and medical intervention, as well as visual representation of the function of organs and tissues, such as magnetic resonance imaging (MRI), ultrasound (US), or computed tomography (CT). For example, lung ultrasound (LUS) is an imaging technique deployed at the point of care for the evaluation of pulmonary and infectious diseases, including COVID-19 pneumonia. Important clinical features—such as B-lines, merged B-lines, pleural line changes, consolidations, and pleural effusions—can be visualized under LUS, but accurately identifying these clinical features requires clinical expertise. Other imaging modalities and/or applications present similar challenges related to feature localization (e.g., detection and/or segmentation). Feature localization using artificial intelligence (AI)/machine learning (ML) models can aid in disease diagnosis, clinical decision-making, patient management, and the like. Other imaging modalities and/or applications can similarly benefit from automated feature detection and/or segmentation.

### SUMMARY

Apparatuses, systems, and methods for training models to perform feature localization using video-level annotations as additional supervision for medical images are disclosed. As used herein, a video-level annotation can be an annotation describing or characterizing a medical imaging video, such as a category for the video. A video-level annotation can include, for example, a label indicating presence or absence of one or more target features in a video. The disclosed technology includes a frame-to-video feature encoder that is trained to generate accurate video-level predictions from per-frame bounding box or segmentation predictions. The frame-to-video feature encoder is jointly trained based on video-level annotations, and the joint training allows the model to improve both frame-level and video-level accuracy. The disclosed techniques also include applying one or more trained models to perform feature localization.

In accordance with at least one example disclosed herein, a method of training a model is disclosed. A plurality of medical imaging data is received, including a first set of medical imaging data comprising frame-level annotations and a second set of medical imaging data comprising video-level annotations. A training dataset is generated, comprising frame-level ground truth data and video-level ground truth data. The model is trained, using the generated training dataset, to generate frame-level predictions and video-level predictions based on new medical imaging data.

In accordance with at least one example disclosed herein, a non-transitory computer-readable medium is disclosed carrying instructions that, when executed, cause a processor to perform operations. The operations include receiving a plurality of medical imaging data including a first set of medical imaging data comprising frame-level annotations and a second set of medical imaging data comprising video-level annotations, generating a training dataset comprising frame-level ground truth data and video-level ground truth data, and training a model using the generated training dataset to generate frame-level predictions and video-level predictions based on new medical imaging data.

In some implementations of the disclosed method and/or the non-transitory computer-readable medium, the video-level annotations comprise categories selected from a plurality of categories for videos included in the medical imaging data. In some implementations, the video-level predictions include predicted categories of the plurality of categories for the new medical imaging data. In some implementations, the new medical imaging data comprises an ultrasound video loop. In some implementations, the plurality of medical imaging data comprises ultrasound videos, ultrasound frames, or both. In some implementations, training the model comprises training a first model to generate the frame-level predictions and training a second model to generate the video-level predictions. In some implementations, the model comprises a frame-to-video feature encoder. In some implementations, the frame-to-video feature encoder comprises a graph neural network (GNN). In some implementations, the frame-to-video feature encoder comprises a trainable feature aggregator. In some implementations, training the model includes determining weights to combine the frame-level predictions, and the video-level predictions are based on the determined weights. In some implementations, the frame-to-video feature encoder combines the frame-level predictions based on predetermined operations, and the predetermined operations are based on at least one of a confidence score or a size of a target feature. In some implementations, the model is trained to detect a target feature in the new medical imaging data. In some implementations, the model is trained to perform segmentation using the new medical imaging data. In some implementations, the model includes a first model to generate the frame-level predictions, the frame-level predictions including bounding boxes or segmentations corresponding to predicted locations of at least one target feature in at least some frames of the new medical imaging data, and a second model to generate the video-level predictions, the video-level predictions being based on the frame-level predictions. In some implementations, the first model and the second model are trained jointly. In some implementations, the claimed method and/or the operations include applying the trained model to the new medical imaging data to generate the frame-level predictions and the video-level predictions. In some implementations, the claimed method and/or the operations includes evaluating an accuracy of the trained model using a testing dataset and retraining the trained model using a different training dataset when the accuracy does not exceed a threshold accuracy. In some implementations, the model includes a frame-level localization algorithm.

Other examples disclosed herein include systems or apparatuses configured to perform one or more methods described herein, such as ultrasound imaging systems and/or computing systems.

### BRIEF DESCRIPTION OF THE DRAWINGS

FIG. 1 is a block diagram of an ultrasound imaging system arranged in accordance with principles of the present disclosure.

FIG. 2 is a block diagram illustrating a workflow for training a model using video-level annotations, according to principles of the present disclosure.

FIG. 3 is a block diagram illustrating a workflow for training a detection model using frame-level annotations, according to principles of the present disclosure.

FIG. 4 is a block diagram illustrating a workflow for training a segmentation model using frame-level annotations, according to principles of the present disclosure.

FIG. 5 is a block diagram illustrating a workflow for a detection task using frame-level and video-level labels, according to principles of the present disclosure.

FIG. 6 is a block diagram illustrating a workflow for a segmentation task using frame-level and video-level labels, according to principles of the present disclosure.

FIG. 7 is a block diagram illustrating a frame-to-video feature encoder, according to principles of the present disclosure.

FIG. 8 is a block diagram illustrating a frame-to-video feature encoder, according to principles of the present disclosure.

FIG. 9 is a block diagram illustrating a workflow for a segmentation task using frame-level and video-level labels, according to principles of the present disclosure.

FIG. 10 is a flow diagram illustrating a process for training a model using video-level labeled data, according to principles of the present disclosure.

### DESCRIPTION

The following description of certain examples is merely illustrative in nature and is in no way intended to limit the invention or its applications or uses. In the following detailed description of examples of the present apparatuses, systems, and methods, reference is made to the accompanying drawings which form a part hereof, and in which are shown by way of illustration specific examples in which the described apparatuses, systems and methods may be practiced. These examples are described in sufficient detail to enable those skilled in the art to practice the presently disclosed apparatuses, systems and methods, and it is to be understood that other examples may be utilized and that structural and logical changes may be made without departing from the spirit and scope of the present disclosure. Moreover, for the purpose of clarity, detailed descriptions of certain features will not be discussed when they would be apparent to those with skill in the art so as not to obscure the description of the present system. The following detailed description is therefore not to be taken in a limiting sense, and the scope of the present technology is defined only by the appended claims.

Although artificial intelligence (AI) techniques, including machine learning (ML) techniques, have been applied to medical images, such as to generate annotations, various technical challenges arise. Existing technologies for training AI algorithms using medical images require extensive training data with expert human annotations (e.g., hundreds or thousands of frame-level annotations) of high clinical quality. For example, frame-by-frame annotation of a single cineloop ultrasound video (e.g., video loop) can take hours to complete, which makes annotation at scale extremely challenging.

Alternatively, video-level annotations could be used to provide supervision for training of ML models. Rather than painstakingly annotating the location of features in every frame of an ultrasound video (e.g. via bounding boxes or segmentation masks), a single annotation could be provided for the entire video indicating presence or absence of one or more target features. This could be done with relative ease, in some cases in a matter of seconds. However, training frame-level detection or segmentation models using video-level labels is technically challenging because the annotation information is incomplete. That is, a single video-level tag does not contain the information about the location/size/shape of features in each ultrasound frame that would normally be needed to train an ML model to make such predictions. Thus, standard methods based on known network architectures and ML training procedures cannot be applied.

The present disclosure describes systems and related methods for training models, using video-level annotations, to perform feature localization on medical imaging data, such as segmentation models or detection models. The disclosed technology can use video-level annotations to supervise the training of per-frame detection or segmentation models as an alternative to technologies that exclusively use frame-by-frame annotations, which are costly and time consuming to obtain. The disclosed technology includes one or more models that can receive an ultrasound video loop as an input, and the one or more models can generate outputs comprising frame-level predictions for each frame of a video loop, as well as an overall video-level prediction for the loop as a whole. The disclosed technology can include a frame-level localization algorithm, which can be a deep-learning network (e.g., a detection or segmentation model) that takes N frames from the video loop and produces bounding boxes or segmentations corresponding to the predicted locations of one or more target features in each frame. And the disclosed technology can include a frame-to-video feature encoder that combines the predictions from each of the N frames into a single video-level prediction. The disclosed technology jointly trains the frame-level localization algorithm and the frame-to-video feature encoder using a combination of frame-level annotations and video-level annotations, respectively. This joint training may allow the model to simultaneously improve its frame-level and video-level prediction accuracy.

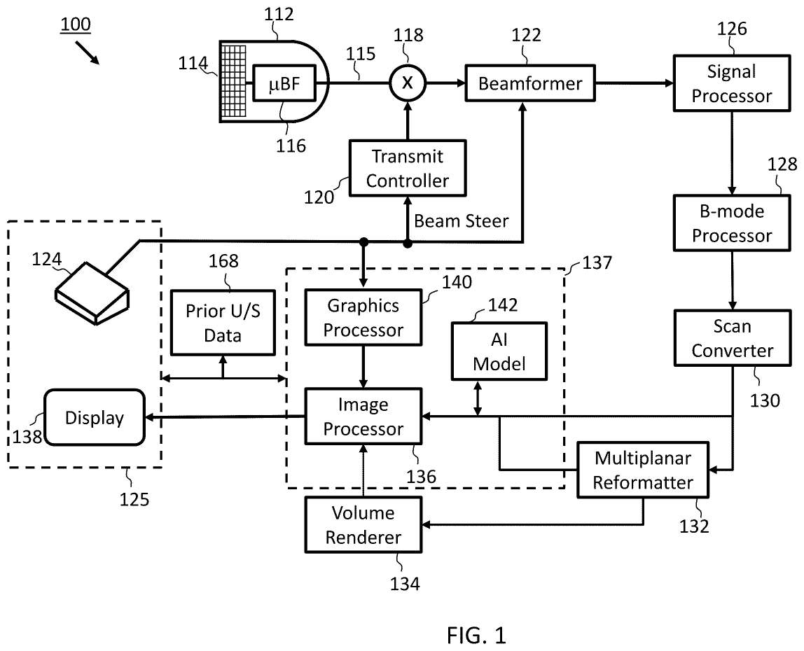

FIG. 1 is a block diagram of an ultrasound imaging system 100 arranged in accordance with principles of the present disclosure. In the ultrasound imaging system 100 of FIG. 1, an ultrasound probe 112 includes a transducer array 114 for transmitting ultrasonic waves and receiving echo information. The transducer array 114 may be implemented as a linear array, convex array, a phased array, and/or a combination thereof. The transducer array 114, for example, can include a two-dimensional array (as shown) of transducer clements capable of scanning in both elevation and azimuth dimensions for 2D and/or 3D imaging. The transducer array 114 may be coupled to a microbeamformer 116 in the probe 112, which controls transmission and reception of signals by the transducer elements in the array. In this example, the microbeamformer 116 is coupled by the probe cable to a transmit/receive (T/R) switch 118, which switches between transmission and reception and protects the main beamformer 122 from high-energy transmit signals. In some embodiments, the T/R switch 118 and other elements in the system can be included in the ultrasound probe 112 rather than in a separate ultrasound system base. In some embodiments, the ultrasound probe 112 may be coupled to the ultrasound imaging system via a wireless connection (e.g., WiFi, Bluetooth).

The transmission of ultrasonic beams from the transducer array 114 under control of the microbeamformer 116 is directed by the transmit controller 120 coupled to the T/R switch 118 and the beamformer 122, which receives input from the user's operation of the user interface (e.g., control panel, touch screen, console) 124. The user interface 124 may include soft and/or hard controls. One of the functions controlled by the transmit controller 120 is the direction in which beams are steered. Beams may be steered straight ahead from (orthogonal to) the transducer array, or at different angles for a wider field of view. The partially beamformed signals produced by the microbeamformer 116 are coupled via channels 115 to a main beamformer 122 where partially beamformed signals from individual patches of transducer elements are combined into a fully beamformed signal. In some embodiments, microbeamformer 116 is omitted and the transducer array 114 is coupled via channels 115 to the beamformer 122. In some embodiments, the system 100 may be configured (e.g., include a sufficient number of channels 115 and have a transmit/receive controller programmed to drive the array 114) to acquire ultrasound data responsive to a plane wave or diverging beams of ultrasound transmitted toward the subject. In some embodiments, the number of channels 115 from the ultrasound probe may be less than the number of transducer elements of the array 114 and the system may be operable to acquire ultrasound data packaged into a smaller number of channels than the number of transducer elements.

The beamformed signals are coupled to a signal processor 126. The signal processor 126 can process the received echo signals in various ways, such as bandpass filtering, decimation, I and Q component separation, and harmonic signal separation. The signal processor 126 may also perform additional signal enhancement such as speckle reduction, signal compounding, and noise elimination. The processed signals are coupled to a B-mode processor 128, which can employ amplitude detection for the imaging of structures in the body. The signals produced by the B-mode processor 128 are coupled to a scan converter 130 and a multiplanar reformatter 132. The scan converter 130 arranges the echo signals in the spatial relationship from which they were received in a desired image format. For instance, the scan converter 130 may arrange the echo signal into a two-dimensional (2D) sector-shaped format, or a pyramidal three-dimensional (3D) image. The multiplanar reformatter 132 can convert echoes, which are received from points in a common plane in a volumetric region of the body into an ultrasonic image of that plane, as described in U.S. Pat. No. 6,443,896 (Detmer).

A volume renderer 134 converts the echo signals of a 3D data set into a projected 3D image as viewed from a given reference point, e.g., as described in U.S. Pat. No. 6,530,885 (Entrekin et al.) The 2D or 3D images may be coupled from the scan converter 130, multiplanar reformatter 132, and volume renderer 134 to at least one processor 137 for further image processing operations. For example, the at least one processor 137 may include an image processor 136 configured to perform further enhancement and/or buffering and temporary storage of image data for display on an image display 138. The display 138 may include a display device implemented using a variety of known display technologies, such as LCD, LED, OLED, or plasma display technology. The at least one processor 137 may include a graphics processor 140, which can generate graphic overlays for display with the ultrasound images. These graphic overlays can contain, e.g., standard identifying information such as patient name, date and time of the image, imaging parameters, and the like. For these purposes the graphics processor 140 receives input from the user interface 124, such as a typed patient name. The user interface 124 can also be coupled to the multiplanar reformatter 132 for selection and control of a display of multiple multiplanar reformatted (MPR) images. The user interface 124 may include one or more mechanical controls, such as buttons, dials, a trackball, a physical keyboard, and others, which may also be referred to herein as hard controls. Alternatively or additionally, the user interface 124 may include one or more soft controls, such as buttons, menus, soft keyboard, and other user interface control elements implemented for example using touch-sensitive technology (e.g., resistive, capacitive, or optical touch screens). One or more of the user controls may be co-located on a control panel. For example one or more of the mechanical controls may be provided on a console and/or one or more soft controls may be co-located on a touch screen, which may be attached to or integral with the console.

The at least one processor 137 may also perform the functions associated with training models using video-level annotations, as described herein. For example, the processor 137 may include or be operatively coupled to an AI model 142. The AI model 142 can include various models, such as a frame-level localization algorithm and a frame-to-video feature encoder, as described herein. The AI model 142 can comprise one or more detection models, segmentation models, or combinations thereof.

A “model,” as used herein, can refer to a construct that is trained using training data to make predictions or provide probabilities for new data items. For example, training data for supervised learning can include items with various characteristics and an assigned classification label. A new data item can have characteristics that a model can take in to assign a classification to the new data item. As another example, a model can be a probability distribution resulting from the analysis of training data, such as a likelihood of an n-gram occurring in a given language based on an analysis of a large corpus from that language. Examples of models include, without limitation: AI models, ML models, neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the AI model 142 can include a neural network with multiple input nodes that receive the input and produce results. These results can be provided to one or more levels of intermediate nodes that each produce further results based on a combination of lower-level node results. A weighting factor can be applied to the output of each node before the result is passed to the next layer node. At the final layer, (“the output layer,”) one or more nodes can produce a value classifying the input that, once the model is trained, can be used to generate predictions based on medical imaging data (e.g., to perform detection tasks or segmentation tasks), and so forth. In some implementations, such neural networks, known as deep neural networks, can have multiple layers of intermediate nodes with different configurations.

A model can be trained with supervised learning. Testing data can then be provided to the model to assess for accuracy. Testing data can be, for example, a portion of the training data (e.g., 10%) held back to use for evaluation of the model. Output from the model can be compared to the desired and/or expected output (e.g., desired or expected labels) for the training data and, based on the comparison, the model can be modified, such as by changing weights between nodes of a neural network and/or parameters of the functions used at each node in the neural network (e.g., applying a loss function). Based on the results of the model evaluation, and after applying the described modifications, the model can then be retrained to evaluate new medical imaging data.

Although described as separate processors, it will be understood that the functionality of any of the processors described herein (e.g., processors 136, 140, 142) may be implemented in a single processor (e.g., a CPU or GPU implementing the functionality of processor 137) or fewer number of processors than described in this example. In yet other examples, the AI model 142 may be hardware-based (e.g., include multiple layers of interconnected nodes implemented in hardware) and be communicatively connected to the processor 137 to output to processor 137 the requisite image data for generating ultrasound images. While in the illustrated embodiment, the AI model 142 is implemented in parallel and/or conjunction with the image processor 136, in some embodiments, the AI model 142 may be implemented at other processing stages, e.g., prior to the processing performed by the image processor 136, volume renderer 134, multiplanar reformatter 132, and/or scan converter 130. In some embodiments, the AI model 142 may be implemented to process ultrasound data in the channel domain, beamspace domain (e.g., before or after beamformer 122), the IQ domain (e.g., before, after, or in conjunction with signal processor 126), and/or the k-space domain. As described, in some embodiments, functionality of two or more of the processing components (e.g., beamformer 122, signal processor 126, B-mode processor 128, scan converter 130, multiplanar reformatter 132, volume renderer 134, processor 147, image processor 136, graphics processor 140, etc.) may be combined into a single processing unit or divided between multiple processing units. The processing units may be implemented in software, hardware, or a combination thereof. For example, AI model 142 may include one or more graphical processing units (GPU). In another example, beamformer 122 may include an application specific integrated circuit (ASIC).

The at least one processor 137 can be coupled to one or more computer-readable media (not shown) included in the system 100, which can be non-transitory. The one or more computer-readable media can carry instructions and/or a computer program that, when executed, cause the at least one processor 137 to perform operations described herein. A computer program may be stored/distributed on any suitable non-transitory medium, such as an optical storage medium or a solid-state medium supplied together with or as part of other hardware, but may also be distributed in other forms, such as via the Internet or other wired or wireless telecommunication systems. Furthermore, the different embodiments can take the form of a computer program product accessible from a computer-readable medium providing program code for use by or in connection with a computer or any device or system that executes instructions. For the purposes of this disclosure, a computer-readable medium can generally be any tangible apparatus that can contain, store, communicate, propagate, or transport the program for use by or in connection with the instruction execution device. The computer-readable medium can be, for example, without limitation, an electronic, magnetic, optical, electromagnetic, infrared, or semiconductor system, or a propagation medium. Non-limiting examples of a computer readable medium include a semiconductor or solid state memory, magnetic tape, a removable computer diskette, a random access memory (RAM), a read-only memory (ROM), a rigid magnetic disk, and/or an optical disk. Optical disks may include compact disk read only memory (CD-ROM), compact disk-read/write (CD-R/W), and/or DVD.

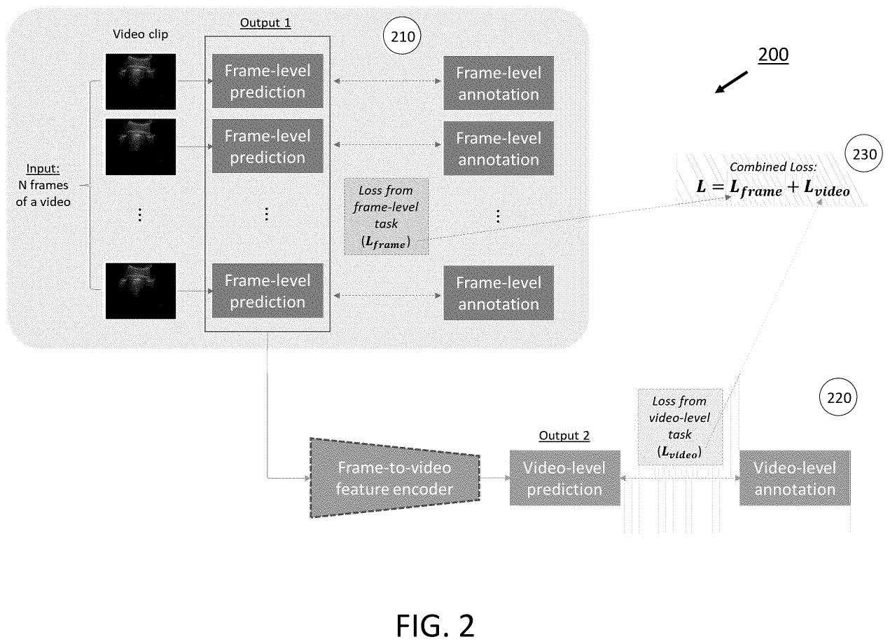

FIG. 2 is a block diagram illustrating a workflow 200 for training a model using video-level annotations, according to principles of the present disclosure. For example, the workflow 200 can be used to train one or more models included in the AI model 142 of FIG. 1. The workflow 200 includes applying a frame-level localization algorithm 210 and a frame-to-video feature encoder 220, which can both be included in the trained model. When trained using the workflow 200, the model can receive inputs comprising medical imaging data and generate outputs comprising frame-level predictions (e.g., feature localizations) and video-level predictions (e.g., categories for videos).

The frame-level localization algorithm 210 receives an input comprising medical imaging data, which can include N frames of a video. The medical imaging data can be acquired, for example, using the system 100 of FIG. 1. The frame-level localization algorithm 210 analyzes the N frames of video to generate a plurality of frame-level predictions. For example, the frame-level predictions can include likely annotations for the frames. The frame-level predictions can include segmentation operations or detection operations (e.g., to detect features present in the frames). For example, frame-level predictions can include bounding boxes or delineations indicating likely locations of one or more target features (e.g., B-lines for LUS). To train the frame-level localization algorithm, the frame-level predictions are compared to frame-level annotations (e.g., frame-level ground truth data) for the frames, and a loss L_{frame} from the frame-level task is calculated based on the comparison.

The frame-level localization algorithm 210 can use or comprise various models, as described herein. In some embodiments, the frame-level localization algorithm 210 is a deep learning network detection or segmentation model, which takes the N frames from the video loop and produces bounding boxes or segmentations corresponding to the predicted locations of one or more target features in each frame. For example, the frame-level localization algorithm 210 may include a deep learning detection model, such as YOLO (You Only Look Once), or a segmentation model, such as U-Net.

The frame-to-video feature encoder 220 aggregates the frame-level predictions generated by the frame-level localization algorithm 210 and outputs a single video-level prediction for the entire ultrasound video clip. The video-level prediction can be a likely category for a video selected from two or more categories. For example, the video-level prediction can be a binary prediction that indicates presence or absence of one or more target features in the video. To train the frame-to-video feature encoder 220, the video-level prediction is compared to a video-level annotation (e.g., video-level ground truth data), and a loss L_{video} from the video-level task is calculated based on the comparison. The frame-to-video feature encoder 220 is jointly trained via backpropagation based on video-level annotations to allow both the frame-level and video-level prediction accuracy to improve during the training process. To jointly train the frame-level localization algorithm 210 and the frame-to-video feature encoder 220, a combined loss 230 is determined using the following equation: L=L_{frame}+L_{video}, where L is the combined loss 230.

The workflow 200 may be complete when a minimum for L is found and/or when L reaches a pre-determined value (e.g., an acceptable loss).

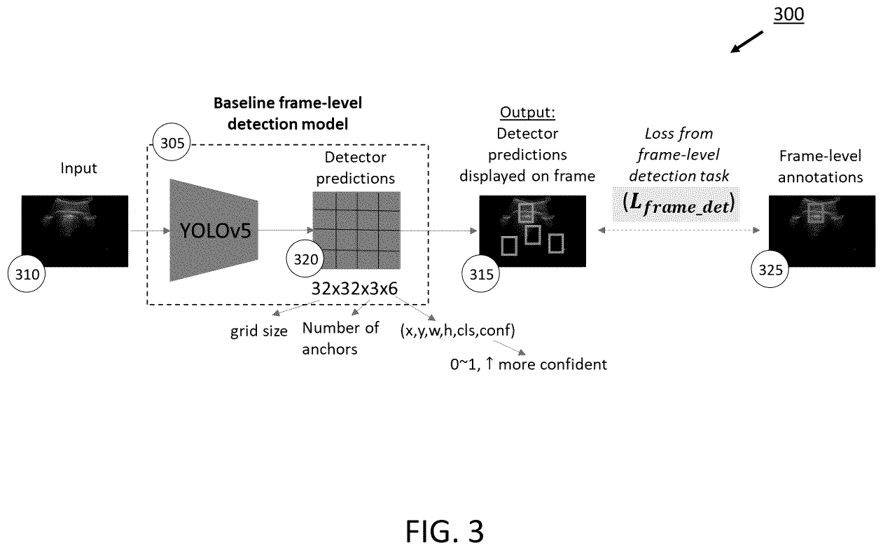

FIG. 3 is a block diagram illustrating a workflow 300 for training a detection model 305 using frame-level annotations, according to principles of the present disclosure. When trained using the workflow 300, the detection model 305 can be applied to detect one or more target features in frames of medical imaging data, such as by generating bounding boxes 315. The detection model 305 can be, for example, the frame-level localization algorithm 210 of FIG. 2. Additionally or alternatively, the detection model 305 can be included in the AI model 142 of FIG. 1. In the illustrated embodiment, the detection model 305 is based, at least in part, on the YOLO (You Only Look Once) architecture. In some implementations, other and/or additional architectures are used. The detection model 305 receives one or more frames as an input 310 and generates detection candidates 320 (e.g., indications of likely target features such as bounding boxes 315) in the form of 6-dimensional vectors containing the following elements: x coordinate, y coordinate, width, height, classification probability, and confidence of the prediction (within the value range of 0 to 1). A plurality of such detection candidates 320 can be generated for each frame (e.g., as many as 32*32*3 detections may be generated per frame). Predicted bounding boxes 315 are then compared with ground truth annotations 325 on the frame to regularize predictions in shape (L2 loss), classification class (cross entropy loss) and confidence (amount of overlap with frame-level annotation, L2 loss). The predicted bounding boxes 315 and/or the ground truth annotations 325 can be displayed on the frame. A loss, L_{frame_det}, from the frame-level detection task can be determined by comparing the predicted boxes and the ground truth annotations. The losses are back-propagated to adjust the weights of the model to improve the predictions in the next iteration. The workflow 300 may be complete when L_{frame_det} reaches a minimum and/or acceptable value.

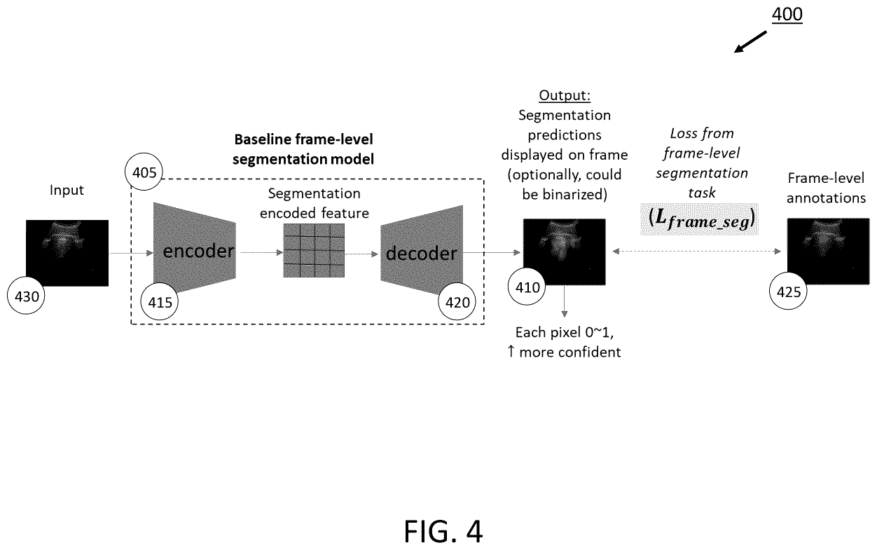

FIG. 4 is a block diagram illustrating a workflow 400 for training a segmentation model 405 using frame-level annotations, according to principles of the present disclosure. When trained using the workflow 400, the segmentation model 405 can be applied to detect one or more target features in frames of medical imaging data to segment the one or more target features, such as by generating segmentation predictions 410 comprising boundaries of one or more target features. The segmentation model 405 can be, for example, the frame-level localization algorithm 210 of FIG. 2. Additionally or alternatively, the segmentation model can be included in the AI model 142 of FIG. 1. In the illustrated embodiment, the segmentation model 405 is based, at least in part, on the U-Net architecture, which may use an encoder 415 and a decoder 420 arranged in an encoder-decoder architecture to output a segmentation prediction 410 comprising a segmentation map of the same width and height dimensions as the input frames. In some implementations, other and/or additional architectures are used. Each pixel in the segmentation map includes a confidence score between 0 and 1. During training, the segmentation map is compared with frame-level segmentation annotations 425 to calculate the segmentation loss. During inference, the predicted probability map can be binarized (for example, using thresholding) to serve as the frame-level output. In the workflow 400, the segmentation model 405 receives one or more frames of medical imaging data as an input 430 and generates segmentation predictions 410 (e.g., segmentation maps for the one or more frames) based on the input 430. In some implementations, the segmentation predictions 410 can be displayed on the one or more frames. A loss, L_{frame_seg}, from the frame-level segmentation task can be determined by comparing the segmentation predictions 410 to frame-level annotations 425 for the frames. The losses are backpropagated to adjust the weights of the model to improve the predictions in the next iteration. The workflow 400 may be complete when L_{frame_seg} reaches a minimum and/or acceptable value.

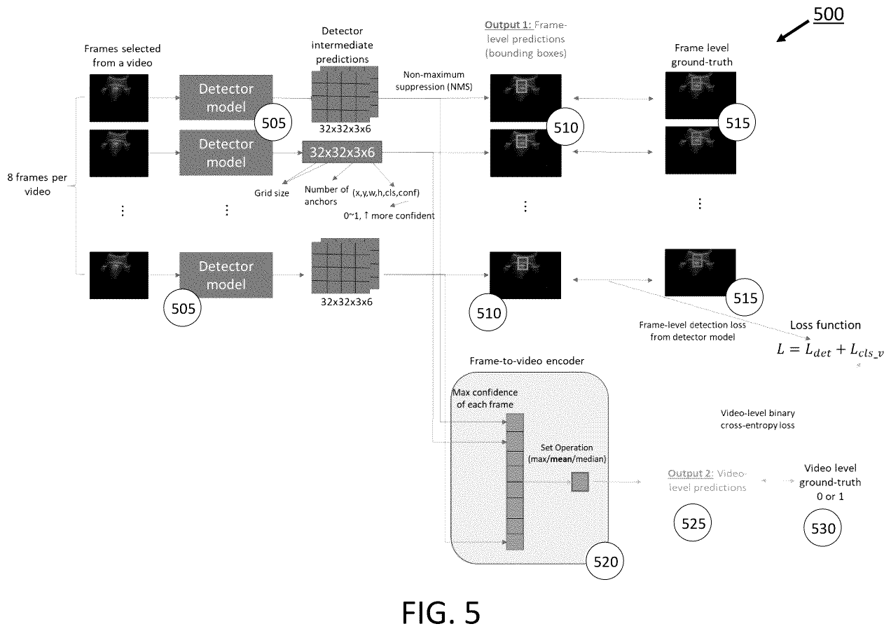

FIG. 5 is a block diagram illustrating a workflow 500 for a detection task using frame-level and video-level annotations, according to principles of the present disclosure. The workflow 500 can be performed using the processor 137 of FIG. 1, such as to train or apply one or more models included in the AI model 142. Additionally or alternatively, the workflow 500 can be performed according to the architecture 200 of FIG. 2.

The workflow 500 can use one or more detection models 505 as frame-level localization algorithms, which can be detection models 505 trained using frame-level annotations, as described in the workflow 300 of FIG. 3. As described with reference to FIG. 3, the detection models 505 are trained to generate frame-level predictions 510, such as bounding boxes. The frame-level predictions 510 are compared to a frame-level ground truth 515, and a frame-level loss function, L_{det}, is determined based on the comparison.

The workflow 500 also uses a frame-to-video feature encoder 520 that combines multiple frame-level predictions 510 generated by the detection models 505 to generate a video-level prediction 525. The frame-to-video feature encoder 520 is trainable based on video-level annotations, which in some applications, can be provided much more efficiently than frame-by-frame annotations required to train a frame-level algorithm. The training process can include jointly training a frame-level localization algorithm (e.g., a detection model 505) and the frame-to-video feature encoder 520 using a combination of frame-level annotations and video-level annotations, respectively. This is done by comparing video-level predictions 525 generated by the frame-to-video feature encoder 520 with ground-truth video-level annotations 520 as a video-level loss component, L_{cls_v} along with the frame-level loss component, L_{det}. A combined loss function, L, can be determined as the sum of the frame-level loss, L_{det}, and the video-level loss component, L_{cls_v}. The training may occur until a minimum and/or acceptable value of L is obtained.

Joint training of the frame-level localization algorithm (e.g., detection models 505) and the frame-to-video feature encoder 520 allows the combined model to simultaneously improve its frame-level and video-level prediction accuracy during the training process.

In some implementations, the frame-to-video feature encoder 520 combines frame-level predictions 510 to a video-level prediction 525 based on fixed or predetermined operations, such as calculating a maximum confidence score. Within a frame, the most confident detection (or, in the case of segmentation, the pixel with the highest prediction probability) is used to represent the confidence from a given frame. The confidences from all frames are then aggregated using another fixed or predetermined operation (e.g., max, median or mean across frames) as the final video-level label.

In some implementations, other metrics may be used in place of, or in addition to, the confidence scores. The metrics can be fixed or predetermined to represent clinically relevant parameters derived from the detections. For example, in a screening/triage context, a user may be interested in picking up features of any size, as long as they have been detected with sufficient confidence. In this setting, a metric such as the maximum confidence of all detections may be appropriate. In a diagnostic context, a user may already know that very small findings are not clinically significant but that larger findings may indicate pathology. Therefore, a metric may be defined as the maximum of all detection areas, or the maximum of a product of area and confidence of all detections. This way, the metric would not be sensitive to small findings (even those with high confidence).

In some implementations, still other metrics could be considered depending on clinical settings, including: max confidence of all detections; max area of all detections; number of detections that exceed a minimum confidence and/or a minimum area; max product of confidence and area of a feature type; average of the highest confidence in each frame; average of the largest area in each frame; average number of detections that exceed a minimum confidence in each frame; or combinations of the above.

Regardless of the specific metrics or combinations of metrics used, the derivation of the metrics can be done during the training process. Thus, while the fixed metric calculation itself is not trainable (since it is a fixed, predefined operation), the model still learns to improve the frame-level prediction accuracy as a byproduct of achieving high video-level classification performance.

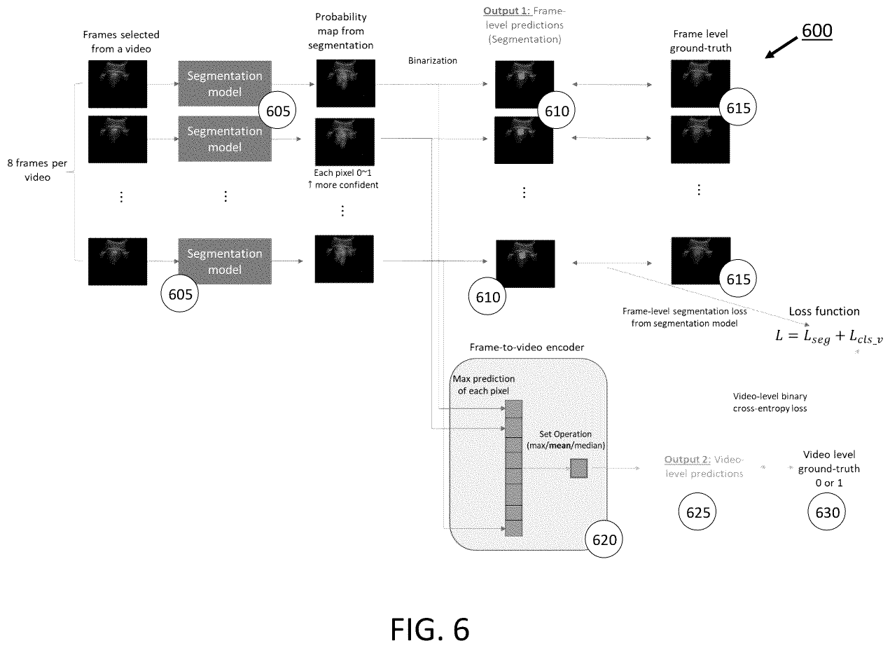

FIG. 6 is a block diagram illustrating a workflow 600 for a segmentation task using frame-level and video-level annotations, according to principles of the present disclosure. The workflow 600 can be performed using the processor 137 of FIG. 1, such as to train or apply one or more models included in the AI model 142. Additionally or alternatively, the workflow 600 can be performed according to the architecture 200 of FIG. 2. Generally speaking, the workflow 600 extends the use of fixed or predetermined operations, as described with reference to the workflow 500, to segmentation tasks.

The workflow 600 can use one or more segmentation models 605 as frame-level localization algorithms, which can be segmentation models 605 trained using frame-level annotations, as described in the workflow 400 of FIG.4. As described with reference to FIG. 4, the segmentation models 605 are trained to generate frame-level predictions 610, such as segmentation predictions and/or delineations of likely target features. The frame-level predictions 610 are compared to a frame-level ground truth 615, and a frame-level loss component, L_{seg}, is determined based on the comparison.

The workflow 600 also uses a frame-to-video feature encoder 620 that combines multiple frame-level predictions 610 generated by the segmentation models 605 to generate a video-level prediction 625. The frame-to-video feature encoder 620 is trainable based on video-level annotations, which can be provided much more efficiently than frame-by-frame annotations required to train a frame-level algorithm. The training process can include jointly training a frame-level localization algorithm (e.g., segmentation models 605) and the frame-to-video feature encoder 620 using a combination of frame-level annotations and video-level annotations, respectively. This is done by comparing video-level predictions 625 generated by the frame-to-video feature encoder 620 with ground-truth video-level annotations 630 as video-level loss component, L_{cls_v}, along with the frame-level loss component, L_{seg}. A combined loss function, L, can be determined as the sum of the frame-level loss, L_{seg}, and the video-level loss component, L_{cls_v}. The training may occur until a minimum and/or acceptable value of L is obtained.

Joint training of the frame-level localization algorithm (e.g., segmentation models 605) and the frame-to-video feature encoder 620 allows the combined model to simultaneously improve its frame-level and video-level prediction accuracy during the training process.

In some implementations, the frame-to-video feature encoder 620 combines frame-level predictions 610 to a video-level prediction 625 based on fixed or predetermined operations, such as calculating a maximum confidence score. Within a frame, the most confident detection (or, in the case of segmentation, the pixel with the highest prediction probability) is used to represent the confidence from a given frame. The confidences from all frames are then aggregated using another fixed operation (e.g., max, median or mean across frames) as the final video-level label.

In some implementations, other metrics may be used in place of, or in addition to, the confidence scores. The metrics can be fixed or predetermined to represent clinically relevant parameters derived from the detections. For example, in a screening/triage context, a user may be interested in picking up features of any size, as long as they have been detected with sufficient confidence. In this setting, a metric such as the maximum confidence of all detections may be appropriate. In a diagnostic context, a user may already know that very small findings are not clinically significant but that larger findings may indicate pathology. Therefore, a metric may be defined as the maximum of all detection areas, or the maximum of a product of area and confidence of all detections. This way, the metric would not be sensitive to small findings (even those with high confidence).

In some implementations, still other metrics could be considered depending on clinical settings, including: max confidence of all detections; max area of all detections; number of detections that exceed a minimum confidence and/or a minimum area; max product of confidence and area of a feature type; average of the highest confidence in each frame; average of the largest area in each frame; average number of detections that exceed a minimum confidence in each frame; or combinations of the above.

Regardless of the specific metrics or combinations of metrics used, the derivation of the metrics can be done during the training process. Thus, while the fixed metric calculation itself is not trainable (since it is a fixed, predefined operation), the network still learns to improve the frame-level prediction accuracy as a byproduct of achieving high video-level classification performance.

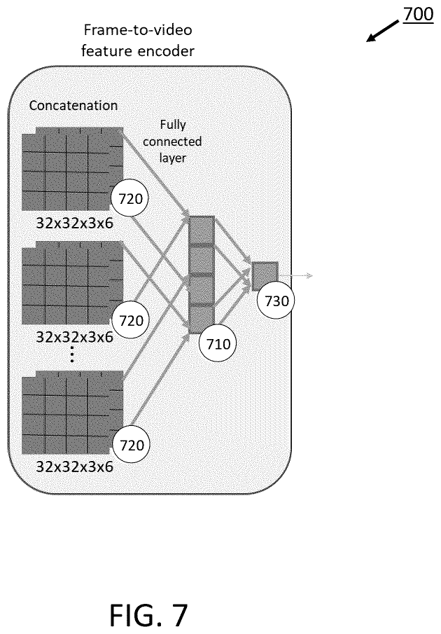

FIG. 7 is a block diagram illustrating a frame-to-video feature encoder 700, according to principles of the present disclosure. When trained, the frame-to-video feature encoder 700 can receive inputs comprising frame-level predictions and generate outputs comprising video-level predictions. The frame-to-video feature encoder 700 can be the frame-to-video feature encoder 220 of FIG. 2. Additionally or alternatively, the frame-to-video feature encoder 700 can be included in the AI model 142 of FIG. 1. In the illustrated embodiment, the frame-to-video feature encoder comprises a trainable component of the overall network architecture, such as a trainable feature aggregator. Using the frame-to-video feature encoder 700, the aggregation of features from frame-level to video-level is not done using fixed or predetermined rules (e.g. maximum confidence in each frame, then mean of all frames, as described elsewhere herein). Instead, a fully-connected layer 710 is used to learn weights to combine all frame-level features directly from the data.

Using the illustrated embodiment to perform a detection task, the frame-to-video feature encoder 700 receives an input 720 comprising an output of a detection model (e.g., a model trained using the workflow 300 of FIG. 3). The received input 720 can include detection candidates (e.g., indications of likely target features such as bounding boxes) in the form of 6-dimensional vectors containing the following elements: x coordinate, y coordinate, width, height, classification probability, and confidence of the prediction (within the value range of 0 to 1). A plurality of such detection candidates can be received for each frame (e.g., as many as 32*32*3 detections may be generated per frame). The detection candidates for all frames are concatenated and flattened to be a feature vector with 8*32*32*3*6 dimension. With one or multiple fully-connected layers 710, the feature vector is reduced to 1 dimension to generate an output 730 (e.g., a video-level prediction), which is compared with the video-level annotation.

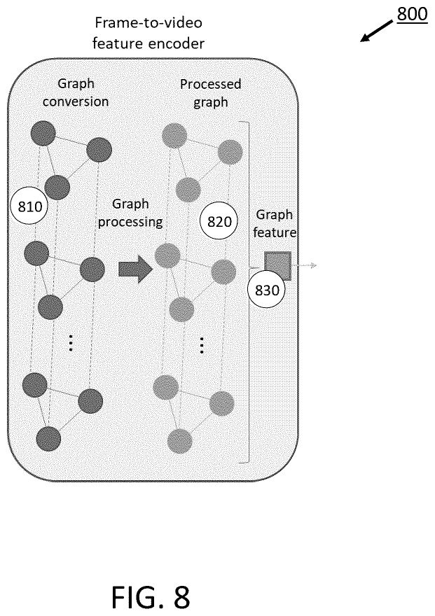

FIG. 8 is a block diagram illustrating a frame-to-video feature encoder 800, according to principles of the present disclosure. When trained, the frame-to-video feature encoder 800 can receive inputs comprising frame-level predictions and generate outputs comprising video-level predictions. The frame-to-video feature encoder 800 can be the frame-to-video feature encoder 220 of FIG. 2. Additionally or alternatively, the frame-to-video feature encoder 800 can be included in the AI model 142 of FIG. 1. In the illustrated embodiment, the frame-to-video feature encoder 800 comprises a trainable feature aggregator, which is a graph neural network (GNN). Outputs of a detection model (e.g., predictions above a certain confidence threshold) from multiple frames are represented as a graph 810 with inter-connected nodes (each node represents one detection). Detector features (x, y coordinates, width, height, classification probability and confidence) are used as node features. The GNN is trained to process features between nodes and edges to generate a processed graph 820, finally generating a 1-dimensional graph-level property value, 830 which can be used as video-level classification probability. During training, the predicted graph-level property value is trained to predict the annotated video-level label.

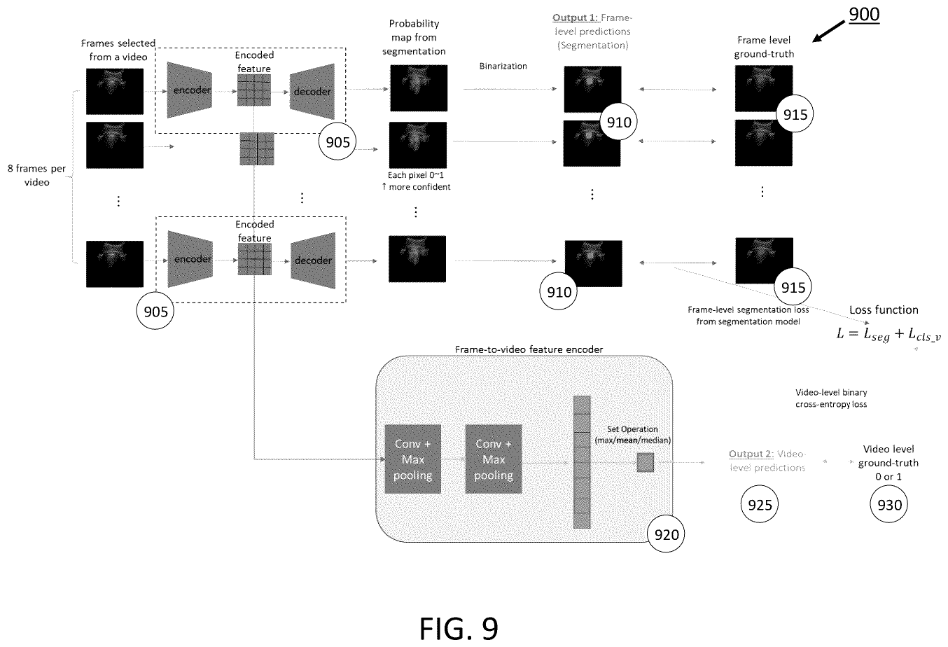

FIG. 9 is a block diagram illustrating a workflow 900 for a segmentation task using frame-level and video-level annotations, according to principles of the present disclosure. The workflow 900 can be performed using the processor 137 of FIG. 1, such as to train or apply one or more models included in the AI model 142. Additionally or alternatively, the workflow 900 can be performed according to the architecture 200 of FIG. 2. Generally speaking, the workflow 900 is similar to the workflow 600, except that different segmentation models 905 are applied and a different frame-to-video feature encoder 920 is applied.

The workflow 900 can use one or more segmentation models 905 as frame-level localization algorithms, which can be segmentation models 905 trained using frame-level annotations, as described in the workflow 400 of FIG.4. Each segmentation model 905 can include an encoder and a decoder. As described with reference to FIG. 4, the segmentation models 905 are trained to generate frame-level predictions 910, such as segmentation predictions and/or delineations of likely target features. The frame-level predictions 910 are compared to a frame-level ground truth 915, and a frame-level loss component, L_{seg}, is determined based on the comparison.

The workflow 900 uses a frame-to-video feature encoder 920 that combines multiple frame-level predictions 910 generated by the segmentation models 905 to generate a video-level prediction. The one or more segmentation models 905 and the frame-to-video feature encoder 920 are jointly trained using a combination of frame-level annotations and video-level annotations, respectively. This is done by comparing video-level predictions 925 generated by the frame-to-video feature encoder 920 with ground-truth video-level annotations 930 as video-level loss component, L_{cls_v}, along with the frame-level loss component, L_{seg}. A combined loss function, L, can be determined as the sum of the frame-level loss, L_{seg}, and the video-level loss component, L_{cls_v}. The model may be trained until a minimum and/or acceptable value for L is found.

For segmentation tasks, the input for the frame-to-video feature encoder 920 is from the feature map of an intermediate layer of the segmentation model (for example, the encoder output if using U-Net architecture for segmentation). After several convolutional layers and max-pooling layers, followed by one or more fully connected layers, the feature size is reduced to 1 dimension as the video-level output, which is compared with video-level annotation to be the the video-level loss component, L_{cls_v}.

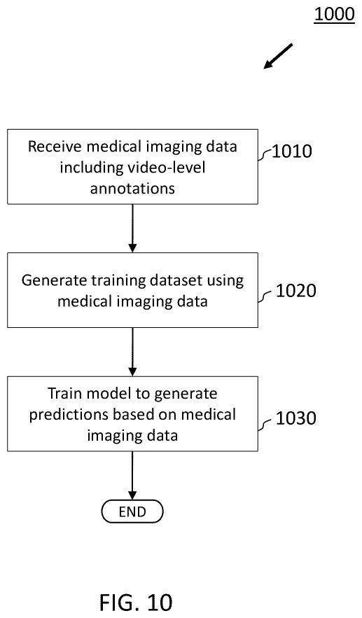

FIG. 10 is a flow diagram illustrating a process 1000 for training a model using video-level labeled data, according to principles of the present disclosure. The process 1000 can be performed, for example, using the processor 137 of FIG. 1 to train one or more models included in the AI model 142. When trained using the process 1000, the model can be applied to perform feature localization (e.g., detection or segmentation) based on received medical imaging data and/or to generate one or more video-level annotations. The model trained using the process 1000 can include for example, a frame-to-video feature encoder (e.g., 700 of FIG. 7 or 800 of FIG. 8) and/or a frame-level localization algorithm, such as a detection model or a segmentation model. The process 1000 can be used in conjunction with any of workflows, 200, 300, 400, 500, or 600, to train one or more models to generate predictions using video-level annotations.

The process 1000 begins at block 1010, where a plurality of medical imaging data is received. The plurality of medical imaging data includes a first set of medical imaging data comprising frame-level annotations and a second set of medical imaging data comprising video-level annotations. In some implementations, annotations included in the second set of medical imaging data comprise only video-level annotations. The medical imaging data can comprise, for example, ultrasound videos (e.g., cineloops), each video including a plurality of frames. The frame-level annotations can include indications of target features in frames, such as bounding boxes or segmentation masks. The video-level annotations can include indications of target features in videos, such as binary indications of presence or absence of a target feature or category information for the video and/or category information.

The process 1000 proceeds to block 1020, a training dataset is generated using the plurality of medical imaging data received at block 1010. The training dataset can comprise frame-level labeled ground truth data (e.g., known feature localization data included in the first set of medical imaging data) and video-level labeled ground truth data (e.g., known video annotations included in the second set of medical imaging data).

The process 1000 proceeds to block 1030, where the model is trained to generate predictions based on new medical imaging data (e.g., medical imaging data that has not previously been seen by the model), including frame-level annotations and video-level annotations. For example, the model can be trained to detect a target feature in medical imaging data (e.g., ultrasound cineloops) and/or the model can be trained to perform segmentation on medical imaging data. The new medical imaging data can comprise ultrasound video, which can be recorded or captured in real time.

In some implementations, the process 1000 includes applying the trained model to generate predictions using the new medical imaging data. The trained model receives the new medical imaging data and processes the medical imaging data to generate frame-level predictions and/or video-level predictions. For example, the frame-level predictions can include bounding boxes indicating locations of predicted target features or delineations of boundaries of predicted target features. Video-level predictions can include predicted categories for a video, such as predictions as to whether a target feature is present or absent in the video.

In some implementations, process 1000 includes testing the trained model. For example, a portion of the medical imaging data (e.g., 10%) received at block 1010 can be excluded from the training dataset and used as test data to assess the accuracy of the trained model and/or to validate the trained model. The trained model is applied to the test data to determine whether the model correctly performs feature localization with an accuracy beyond a threshold level (e.g., 70% accurate, 80% accurate, 90% accurate, etc.). If the trained model does not exceed the threshold accuracy when applied to the test data then the model can be retrained or discarded in favor of a more accurate model. Retraining the model can include training the model at least a second time using the same training dataset, training the model with a different (e.g., expanded) training dataset, applying different weights to a training dataset, rebalancing a training dataset, and so forth.

The systems and related methods for training models disclosed herein jointly trains a frame-level localization algorithm and a frame-to-video feature encoder using a combination of frame-level annotations and video-level annotations, respectively. This joint training may allow the model to simultaneously improve its frame-level and video-level prediction accuracy. This may reduce the need for extensive frame-by-frame annotations by experts to train models.

In various examples where components, systems and/or methods are implemented using a programmable device, such as a computer-based system or programmable logic, it should be appreciated that the above-described systems and methods can be implemented using any of various known or later developed programming languages, such as “Python”, “C”, “C++”, “FORTRAN”, “Pascal”, “VHDL” and the like. Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform functions of the systems and/or methods described herein. For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods described above.

In view of this disclosure it is noted that the various methods and devices described herein can be implemented in hardware, software, and/or firmware. Further, the various methods and parameters are included by way of example only and not in any limiting sense. In view of this disclosure, those of ordinary skill in the art can implement the present teachings in determining their own techniques and needed equipment to affect these techniques, while remaining within the scope of the invention. The functionality of one or more of the processors described herein may be incorporated into a fewer number or a single processing unit (e.g., a CPU) and may be implemented using application specific integrated circuits (ASICs) or general-purpose processing circuits which are programmed responsive to executable instructions to perform the functions described herein.

Although the present system may have been described with particular reference to an ultrasound imaging system, it is also envisioned that the present system can be extended to other medical imaging systems where one or more images are obtained in a systematic manner. Accordingly, the present system may be used to obtain and/or record image information related to, but not limited to renal, testicular, breast, ovarian, uterine, thyroid, hepatic, lung, musculoskeletal, splenic, cardiac, arterial and vascular systems, as well as other imaging applications related to ultrasound-guided interventions. Further, the present system may also include one or more programs which may be used with conventional imaging systems so that they may provide features and advantages of the present system. Certain additional advantages and features of this disclosure may be apparent to those skilled in the art upon studying the disclosure, or may be experienced by persons employing the novel system and method of the present disclosure. Another advantage of the present systems and method may be that conventional medical image systems can be easily upgraded to incorporate the features and advantages of the present systems, devices, and methods.

Of course, it is to be appreciated that any one of the examples, examples or processes described herein may be combined with one or more other examples, examples and/or processes or be separated and/or performed amongst separate devices or device portions in accordance with the present systems, devices and methods.

Finally, the above-discussion is intended to be merely illustrative of the present systems and methods and should not be construed as limiting the appended claims to any particular example or group of examples. Thus, while the present system has been described in particular detail with reference to exemplary examples, it should also be appreciated that numerous modifications and alternative examples may be devised by those having ordinary skill in the art without departing from the broader and intended spirit and scope of the present systems and methods as set forth in the claims that follow. Accordingly, the specification and drawings are to be regarded in an illustrative manner and are not intended to limit the scope of the appended claims.

What is claimed is:

1. A method of training a model to generate predictions using medical images, the method comprising:
receiving a plurality of medical imaging data, wherein the plurality of medical imaging data includes a first set of medical imaging data comprising frame-level annotations and a second set of medical imaging data comprising video-level annotations;
generating a training dataset, wherein the training dataset comprising frame-level ground truth data and video-level ground truth data; and
training, using the generated training dataset, a model to generate frame-level predictions and video-level predictions based on new medical imaging data.

2. The method of claim 1, wherein the video-level annotations comprise categories selected from a plurality of categories for videos included in the second set of medical imaging data, and wherein the video-level predictions include predicted categories of the plurality of categories for the new medical imaging data.

3. The method of claim 1, wherein the new medical imaging data comprises an ultrasound video loop, and wherein the plurality of medical imaging data comprises ultrasound videos, ultrasound frames, or both.

4. The method of claim 1, wherein training the model comprises training a first model to generate the frame-level predictions and training a second model to generate the video-level predictions.

5. The method of claim 1, wherein the model comprises a frame-to-video feature encoder.

6. The method of claim 5, wherein the frame-to-video feature encoder comprises a trainable feature aggregator, wherein training the model includes determining weights to combine the frame-level predictions, and wherein the video-level predictions are based on the determined weights.

7. The method of claim 5, wherein the frame-to-video feature encoder combines the frame-level predictions based on predetermined operations, and wherein the predetermined operations are based on at least one of a confidence score or a size of a target feature.

8. The method of claim 5, wherein the frame-to-video feature encoder comprises a graph neural network (GNN).

9. The method of claim 1, wherein the model is trained to detect a target feature in the new medical imaging data.

10. The method of claim 1, wherein the model is trained to perform segmentation using the new medical imaging data.

11. The method of claim 1, wherein the model includes:
a first model to generate the frame-level predictions, wherein the frame-level predictions include bounding boxes or segmentations corresponding to predicted locations of at least one target feature in at least some frames of the new medical imaging data; and
a second model to generate the video-level predictions, wherein the video-level predictions are based on the frame-level predictions.

12. The method of claim 11, wherein the first model and the second model are trained jointly.

13. The method of claim 1, further comprising:
applying the trained model to the new medical imaging data to generate the frame-level predictions and the video-level predictions.

14. The method of claim 1, further comprising:
evaluating an accuracy of the trained model using a testing dataset; and
retraining the trained model using a different training dataset when the accuracy does not exceed a threshold accuracy.

15. The method of claim 1, wherein the model includes a frame-level localization algorithm.

16. A non-transitory computer-readable medium carrying instructions that, when executed by a processor, cause the processor to perform operations comprising:
receive a plurality of medical imaging data, wherein the plurality of medical imaging data includes a first set of medical imaging data comprising frame-level annotations and a second set of medical imaging data comprising video-level annotations;
generate a training dataset, wherein the training dataset comprising frame-level ground truth data and video-level ground truth data; and
train, using the generated training dataset, a model to generate frame-level predictions and video-level predictions based on new medical imaging data.

17. The non-transitory computer-readable medium of claim 16, wherein the model comprises a frame-to-video feature encoder.

18. The non-transitory computer-readable medium of claim 17, wherein the frame-to-video feature encoder comprises a graph neural network (GNN).

19. The non-transitory computer-readable medium of claim 17, wherein the frame-to-video feature encoder comprises a trainable feature aggregator, wherein training the model includes determining weights to combine the frame-level predictions, and wherein the video-level predictions are based on the determined weights.

20. The non-transitory computer-readable medium of claim 17, wherein the frame-to-video feature encoder combines the frame-level predictions based on predetermined operations, and wherein the predetermined operations are based on at least one of a confidence score or a size of a target feature.
